(19) United States
(12) Patent Application Publication
(10) Pub. No.: US 2003/0080663 A1
(43) Pub. Date: May 1, 2003

(54) Field emission type cold cathode and method for manufacturing the same and method for manufacturing flat display

(75) Inventor: Fuminori Ito, Tokyo (JP)

Correspondence Address: SUGHRUE MION, PLLC, 2100 Pennsylvania Avenue, NW, Washington, DC, 20037-3213, US

(73) Assignee: NEC CORPORATION

(21) Appl. No.: 10/309,823

(22) Filed: Dec. 5, 2002

Related U.S. Application Data
(62) Division of application No. 09/577,046, filed on May 24, 2000.

(30) Foreign Application Priority Data
May 26, 1999 (JP) 145900/1999

(51) Int. Cl. H01J 1/16; H01J 19/10

(52) U.S. Cl. 313/336

(57) ABSTRACT

A field emission type cold cathode, a flat display and a method for a same are provided which are capable of improving controllability in formation of an emitter and of generating uniform and stable emission current. The emitter composed of a carbon nano-tube having a length being not more than, at least, a film thickness of an insulating layer is formed on a glass substrate on which a conductive layer is formed.

On the emitter are stacked the insulating layer and a gate electrode layer. A part of the insulating layer and the gate electrode layer is etched to cause a gate aperture portion to be formed. The length of the carbon nano-tube is controlled so as to be smaller than that expressed by “d−Vg/Eb”, where “d” represents the thickness of the insulating layer, “Vg” represents a voltage to be applied to the emitter and “Eb” represents dielectric strength.

### BACKGROUND OF THE INVENTION

1. Field of the Invention

The present invention relates to a field emission type cold cathode that can be used as an electron beam source for a flat display, CRT (Cathode-ray Tube), electron microscope, electron beam exposure machine and various electron beam devices.

2. Description of the Related Art

In recent years, a carbon nano-tube is widely used as an emitter material for a field emission type cold cathode. The carbon nano-tube is a hollow cylinder formed by rounding a graphene sheet having an outer diameter being of an order of nano-meters and having a length being 0.5 μm to tens of micrometers and is a minute substance with a high aspect ratio. Because of this, an electric field is apt to be concentrated in an end portion of the carbon nano-tube. It is also expected to have a high emission current density. Moreover, since the carbon nano-tube has a characteristic of being highly stable chemically and physically, it is predicted that the carbon nano-tube resists being affected by adsorption of residual gas in a vacuum, ion bombardment or a like.

An example in which the carbon nano-tube is conventionally used as the field emission type cold cathode is disclosed in Japanese Patent Application Laid-open No. Hei9-221309 as shown in FIG. 21. As depicted in FIG. 21, a carbon nano-tube 8 is formed by irradiating a carbonaceous substrate 7 with an ion, and an electrode 9, an insulating layer 10 and a grid electrode 11 used to draw an electron beam are mounted in a manner that they surround an area where the carbon nano-tube 8 is formed. It is described in the disclosed application that an outer diameter of the carbon nano-tube 8 is 2 nm to 50 nm and its length is 0.1 μm to 5 μm. Though it contains no description about a thickness of the insulating layer 10 and a diameter of an emitter, there is a description that an emission current of 10 mA is generated by applying a voltage of 500 V.

FIGS. 22 and 23 are diagrams showing configurations of a flat display disclosed in Japanese Patent Application Laid-open No. Hei10-199398. As shown in FIGS. 22 and 23, a cathode material 16 composed of graphite having a thickness of 1 μm is mounted on a glass substrate 1. A carbon nano-tube 8 with a thickness of several micrometers is formed on the cathode material 16 by an arc discharge method, laser abrasion method or a like. The carbon nano-tube has a diameter of 10 nm to 40 nm and a length of 0.5 μm to several μm. The carbon nano-tube 8 is formed as an electron emission layer in a line-like form in a direction perpendicular to a paper surface of FIG. 23. On both sides of line-like carbon nano-tube 8 is formed, in a line-like form, an insulating layer 10 composed of a silicon oxide film having a thickness of 7 μm and a width of 20 μm. On its upper layer is disposed a grid electrode 11 used for drawing electrons. By applying a positive voltage to the grid electrode 11 and a negative voltage to the cathode material 16, electrons are emitted in a direction of arrows 17 shown in FIG. 23.

A field emission type cold cathode is disclosed in Japanese Patent Application Laid-open No. Hei10-12124 in which a carbon nano-tube 8 is grown in a small hole formed in an anode oxide film made of aluminum film 12 as shown in FIG. 24. In the disclosed field emission type cold cathode, the aluminum film 12 is stacked on a glass substrate and small holes are formed by performing anodic oxidation treatment on the aluminum film 12. Then, after nickel 13 which becomes a growth nucleus of the carbon nano-tube 8 is buried in the small holes, the carbon nano-tube 8 is allowed to be grown in a methane gas and a hydrogen gas. Reaction temperature is 1000° C. to 1200° C. By using this method, it is possible to grow the carbon nano-tube 8 having an orientation extending in a direction perpendicular to a glass substrate. The fabrication of the field emission type cold cathode is now complete when a grid electrode 11 is mounted. The flat display is formed by mounting a plurality of emitters between which a device separation area 14 is interposed and phosphors 15 placed in a position facing the emitters.

In the conventional field emission type cold cathode, as described above, in which the insulating layer and the gate electrode layer (the grid electrode) are formed in a manner that they surround the emitter, an amount of electrons emitted from the emitter can be controlled by an electric field between the gate and the emitter. The electric field between the gate and emitter is approximately equal to a calculation result obtained by dividing a voltage applied to the gate by a film thickness of the insulating layer. That is, though, in a case of a thick insulating layer, it is necessary to apply a high gate voltage, in a case of a thin insulating layer, it is possible to obtain a same amount of emission currents by applying a low gate voltage. Moreover, since electrons emitted from the emitter have kinetic energy in a direction perpendicular to an emitting direction by a gate potential, an orbit of emission electrons is expanded. Though, in the case of low gate voltage, it is possible to obtain a comparatively highly convergent electron beam, in the case of high gate voltage, the expansion of the electrons increases. In a flat display in which a plurality of pixels are controlled independently, when the emitted electrons are expanded, electrons come into collision with adjacent pixels, thus causing an image to be blurred and a contrast to become low. Therefore, to make an insulating layer thin-film is essential to realization of driving the flat display at a low voltage, miniaturizing a drive circuit, producing the flat display at low costs and suppressing beam expansion.

However, the field emission type cold cathode using the carbon nano-tube as the emitter has the following problems when the insulating layer is to be made thin-film and excellent electron emission characteristics are to be implemented.

A first problem is that it is difficult to planarize a surface of the emitter. An outer diameter of the carbon nano-tube obtained by an arc discharge method or laser abrasion method, which is a general method for producing the carbon nano-tube, is almost constant and is of an order of nanometers, however, its length varies in a range of 0.5 μm to 100 μm. Also, the carbon nano-tubes, due to their rich flexibility, easily get interwound with each other. Because of this, if the carbon nano-tubes each having a large length get interwound, their shape becomes similar to waste pieces of thread, causing flatness of the emitter to be reduced. Moreover, a crude carbon nano-tube immediately after being produced contains graphite or amorphous carbon. In a case of a single-layered carbon nano-tube, besides the graphite or amorphous carbon, it contains catalytic metal. The carbon nano-tube easily gets interwound with such impurities and readily forms great flocks after being interwound. As shown in FIG. 25, these locally protruding portions cause an insulating layer 4 and a gate electrode layer 5 to be bent and potential distribution to be not uniform. Moreover, if the locally protruding portions are produced at a gate aperture portion, an electric field is concentrated in the gate aperture portion, causing uniformity of the electron emission characteristic to be worsened. Furthermore, in a flat display in which a plurality of emitters is arranged in a two-dimensional form, such locally protruding portions causes non-uniformity in characteristics among emitters pixels) and variations in an image.

A second problem is that the gate electrode layer 5 and the emitter layer 3 are conducting through the carbon nano-tube. If the carbon nano-tube having a length being greater than a film thickness of the insulating layer occurs on a surface of the emitter layer 3, it contacts with the gate electrode layer 5, bringing the gate electrode layer 5 and the emitter layer 3 into conduction. Such a short circuit between the emitter layer 3 and the gate electrode layer 5 causes a reduction of amounts of emitted electrons and breakdown of devices. As described in the first problem, an electrical short circuit between the gate electrode and the emitter causes non-uniformity in electron emission characteristics, especially unstable images and variations in images in the flat display.

The Japanese Patent Application Laid-open No. Hei9-221309 discloses that the length of a carbon nano-tube in a field emission type cold cathode is 0.01 μm to 5 μm. If a thickness of the insulating layer is not more than 5 μm, as described above, there is a possibility that the gate electrode and the emitter are short-circuited by the carbon nano-tube or that the big flock of the carbon nano-tube occurs locally at an internal portion in the gate aperture. In the field emission type cold cathode disclosed in Japanese Patent Application Laid-open No. Hei10-199398, if many carbon nano-tubes having the length being greater than the thickness of the insulating layer being 7 μm are contained in the emitter, a same problem would occur.

Moreover, in the two conventional field emission type cold cathodes, since the carbon nano-tube is grown directly on the substrate, control of the length of the carbon nano-tube is impossible. Therefore, it is difficult to implement a uniform electron emission characteristic by using the conventional method and there is limit in making the insulating layer thin-film.

On the other hand, according to a method disclosed in Japanese Patent Application Laid-open No. Hei10-12124, it is possible to grow the carbon nano-tube in the direction perpendicular to the substrate with high controllability, however, the temperature required for growing the carbon nano-tube is about 1000° C. and its process is very complicated and therefore the method is unsuitable for producing the flat display or the like in which a plurality of emitters is formed on the glass substrate.

### SUMMARY OF THE INVENTION

In view of the above, it is an object of the present invention to provide a field emission type cold cathode in which insulation between a gate electrode and an emitter is maintained, flatness on a surface of the emitter is improved and uniform and stable high emission current can be produced.

It is another object of the present invention to provide a method for manufacturing the field emission type cold cathode described above.

It is a still further object of the present invention to provide a method for manufacturing a flat display containing the method for manufacturing the field emission type cold cathode described above.

According to a first aspect of the present invention, there is provided a field emission type cold cathode including:

an emitter composed of a carbon nano-tube;

an insulating layer disposed so as to surround the emitter;

a gate electrode; and

whereby an electron is emitted by applying a voltage to the emitter and a length of the carbon nano-tube is smaller than a film thickness of the insulating layer.

In the foregoing, a preferable mode is one wherein the length of the carbon nano-tube is smaller than that expressed by “d−Vg/Eb”, where “d” represents the film thickness of the insulating layer, “Vg” represents the voltage to be applied to the emitter and “Eb” represents dielectric strength of the insulating layer.

According to a second aspect of the present invention, there is provided a method for manufacturing a field emission type cold cathode including steps of:

fixing an emitter material composed of a carbon nano-tube having a length being smaller than a film thickness of an insulating layer on a conductive layer formed on a conductive substrate or a glass substrate;

forming the insulating layer and a gate electrode layer, in order, on the emitter material; and

etching the insulating layer and the gate electrode layer to cause an aperture portion to be formed.

According to a third aspect of the present invention, there is provided a method for manufacturing a field emission type cold cathode including steps of:

forming an insulating layer and a gate electrode layer, in order, on a conductive layer formed on a conductive substrate or a glass substrate;

etching the insulating layer and the gate electrode layer to cause an aperture portion to be formed;

fixing an emitter material composed of a carbon nano-tube a length of which is controlled so as to be smaller than, at least, a film thickness of the insulating layer on the aperture portion and the gate electrode layer; and

etching the emitter material to cause the emitter material to be left only in a gate aperture portion.

In the foregoing, a preferable mode is one wherein control of the length of the carbon nano-tube is made by filtering the carbon nano-tube to separate and extract the carbon nano-tube having a specified length.

Also, a preferable mode is one wherein control of the length of the carbon nano-tube is made by pulverizing and filtering the carbon nano-tube to separate and extract the carbon nano-tube having a specified length.

Also, a preferable mode is one wherein control of the length of the carbon nano-tube is made by heating the carbon nano-tube in a gas containing an oxidizing agent including oxygen and by filtering the carbon nano-tube to separate and extract the carbon nano-tube having a specified length.

Furthermore, a preferable mode is one wherein control of the length of the carbon nano-tube is made by irradiating the carbon nano-tube with an ion beam and by filtering the carbon nano-tube to separate and extract the carbon nano-tube having a specified length.

According to a fourth aspect of the present invention, there is provided a method for manufacturing a flat display including steps containing processes for manufacturing a field emission type cold cathode designated by any one of above items.

### BRIEF DESCRIPTION OF THE DRAWINGS

The above and other objects, advantages and features of the present invention will be more apparent from the following description taken in conjunction with the accompanying drawings in which:

FIG. 1 is a cross-sectional view of a field emission type cold cathode to explain its manufacturing process according to a first embodiment of the present invention;

FIG. 2 is a cross-sectional view of the field emission type cold cathode to explain its manufacturing process according to the first embodiment of the present invention;

FIG. 3 is a cross-sectional view of the field emission type cold cathode to explain its manufacturing process according to the first embodiment of the present invention;

FIG. 4 is a cross-sectional view of the field emission type cold cathode to explain its manufacturing process according to the first embodiment of the present invention;

FIG. 5 is a cross-sectional view of the field emission type cold cathode to explain its manufacturing process according to the first embodiment of the present invention;

FIG. 6 is a cross-sectional view of a field emission type cold cathode to explain its manufacturing process according to a second embodiment of the present invention;

FIG. 7 is a cross-sectional view of the field emission type cold cathode to explain its manufacturing process according to the second embodiment of the present invention;

FIG. 8 is a cross-sectional view of the field emission type cold cathode to explain its manufacturing process according to the second embodiment of the present invention;

FIG. 9 is a cross-sectional view of the field emission type cold cathode to explain its manufacturing process according to the second embodiment of the present invention;

FIG. 10 is a cross-sectional view of the field emission type cold cathode to explain its manufacturing process according to the second embodiment of the present invention;

FIG. 11 is a cross-sectional view of the field emission type cold cathode to explain its manufacturing process according to the second embodiment of the present invention;

FIG. 12 is a graph showing a relationship between amounts of emitted currents and a gate voltage in the field emission type cold cathode of the present invention;

FIG. 13 is a cross-sectional view of a flat display of FIG. 17 taken along a line A-A to explain its manufacturing process including manufacturing processes for the field emission type cold cathode provided in the first embodiment of the present invention;

FIG. 14 is a cross-sectional view of the flat display of FIG. 17 taken along the line A-A to explain its manufacturing process including manufacturing processes for the field emission type cold cathode provided in the first embodiment of the present invention;

FIG. 15 is a cross-sectional view of the flat display of FIG. 17 taken along the line A-A to explain its manufacturing process including manufacturing processes for the field emission type cold cathode provided in the first embodiment of the present invention;

FIG. 16 is a cross-sectional view of the flat display of FIG. 17 taken along the line A-A to explain its manufacturing process including manufacturing processes for the field emission type cold cathode provided in the first embodiment of the present invention;

FIG. 17 is a top view of an emitter area of the field emission type cold cathode of the present invention;

FIG. 18 is a top view of conventional field emission type cold cathode;

FIG. 19 is a top view of the conventional field emission type cold cathode;

FIG. 20 is a top view of the conventional field emission type cold cathode;

FIG. 21 is a cross-sectional view showing configurations of the conventional field emission type cold cathode;

FIG. 22 is a perspective view of the conventional flat display;

FIG. 23 is a cross-sectional view of conventional flat display;

FIG. 24 is a cross-sectional view of configurations of the conventional field emission type cold cathode; and

FIG. 25 is a cross-sectional view of configurations of the conventional field emission type cold cathode.

### DETAILED DESCRIPTION OF THE PREFERRED EMBODIMENTS

Best modes of carrying out the present invention will be described in further detail using various embodiments with reference to the accompanying drawings.

### First Embodiment

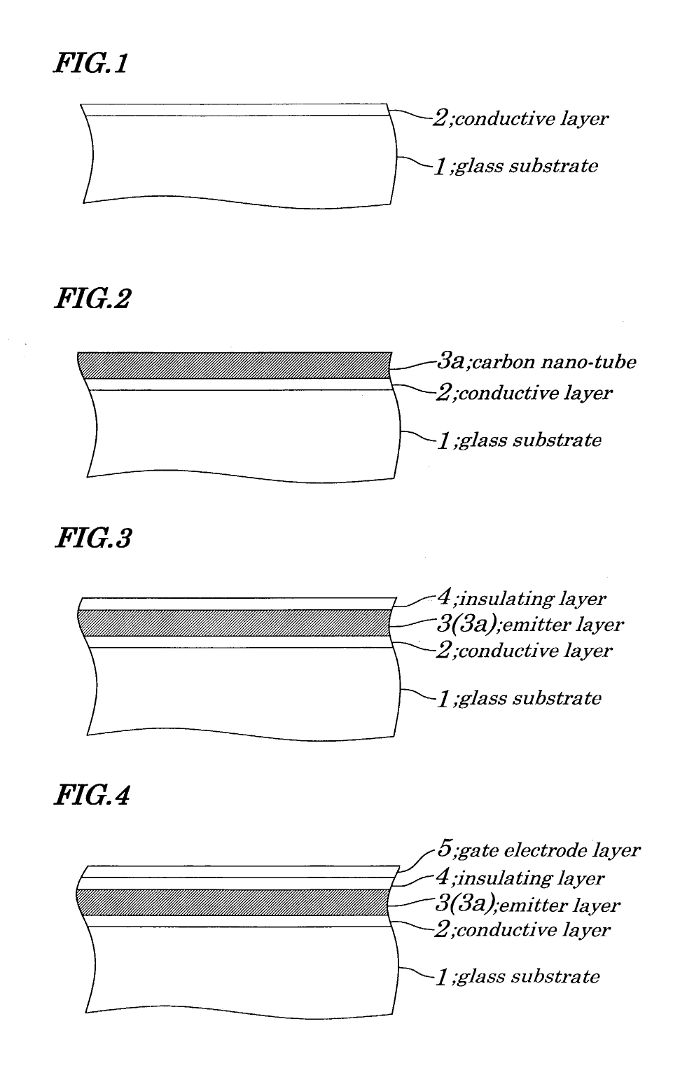

FIGS. 1 to 5 are cross-sectional views of a field emission type cold cathode according to a first embodiment of the present invention. As shown in FIG. 1, a conductive substrate or a glass substrate 1 on which a conductive layer 2 is formed is used as a substrate on which an emitter is also formed. A carbon nano-tube constituting the emitter can be produced, for example, by an arc discharge method or a laser abrasion method. In the first embodiment, the arc discharge method is used to produce the carbon nano-tube. In the arc discharge method, by filling a reaction container with He (Helium) at 500 torr (66,661 Pa) of pressure and by disposing two carbon rods containing catalytic metal so that they face towards each other and to cause the arc discharge to occur between them, a solid containing the carbon nano-tube is accumulated on a surface of an inside-wall of the reaction container. Then, a voltage of 18 V is applied between the two carbon rods and a current of 100 A is fed in order to cause the arc discharge to occur. The produced solid contains, besides the carbon nano-tube, graphite having a grain diameter of 10 nm to 100 nm, amorphous carbon, catalytic metal or a like. The obtained carbon nano-tube is a single carbon nano-tube and its diameter is about 1 nm to 5 nm. Its length is 0.5 μm to 100 μm and its average length is about 2 μm. By using the laser abrasion method, the carbon nano-tube having a same size as that of the carbon nano-tube formed by the arc discharge method can be produced as well. The above crude product is suspended in ethanol and is then pulverized ultrasonically. Then, by using a membrane filter having a pore size of 0.22 μm, a suspension is filtered. Though a minute particle of an impurity passes through the membrane filter, because its size is smaller than the pore size of the membrane filter, the carbon nano-tube having the length being not less than 0.5 μm still stays on the membrane membrane filter. By extracting the carbon nano-tube staying on the membrane filter, only the carbon nano-tube having the length being not less than 0.5 μm can be collected through the membrane filtration. By using a method for purifying the carbon nano-tube disclosed in Japanese Patent Application Laid-open No. Hei8-231210, the carbon nano-tube with higher purity can be obtained. Then, in order to extract the carbon nano-tube having the length being smaller than 1 mm which is equal to a film thickness, the purified carbon nano-tube is again filtered by using the membrane filter having the pore size of 0.8 μm. Though the carbon nano-tube having the length being not less than about 0.8 μm stays on the membrane filter, the carbon nano-tube having the length being not more than 0.8 μm can pass through the membrane filter. By collecting the carbon nano-tube that has passed through the membrane filter, the carbon nano-tube having the length being not more than 0.8 μm, that is, being not more than the film thickness, can be obtained. A method of centrifugal separation can be also used in this process.

The carbon nano-tube obtained in a manner as above is again dispersed in ethanol. The conductive layer 2 is coated with the carbon nano-tube dispersed in ethanol and then is heated to 300° C. for more than 10 minutes in a vacuum or in an inert gas to cause ethanol to be evaporated. From gas analysis, it has been confirmed that the above heat treatment is essential to complete an elimination of ethanol from the carbon nano-tube. Since such thermal elimination of ethanol tends to lower work function of a surface of the carbon nano-tube, amounts of emitted electrons are increased accordingly. However, when the carbon nano-tube is fixed on the conductive layer 2 by using ethanol, since its adhesive force is weak, use of a binder or a like is required to increase the adhesive force. A resist, water glass or a like is used as the binder. The carbon nano-tube is mixed with the binder in a manner that a weight ratio of the binder to the carbon nano-tube is 20:1 and a resulting mixture is ultrasonically stirred. Then, the conductive layer 2 is coated with the binder containing the carbon nano-tube by using a spin coater and is heated to 400 ° C. in the vacuum or in the inert gas such as nitrogen. By this, a carbon nano-tube 3a can be fixed firmly on the conductive layer 2 (FIG. 2). Moreover, in the first embodiment, the carbon nano-tube layer is formed by using the spin coater, however, methods including a screen printing, atomization or a like may be employed as well.

Next, as shown in FIG. 3, after an emitter layer 3 composed of the carbon nano-tube 3a is formed, an insulating layer 4 composed of a silicon oxide film or a polyimide film with a thickness of 1 μm is formed on the emitter layer 3. As shown in FIG. 4, a gate electrode layer 5 with a thickness of 0.5 μm is formed on the insulating layer 4. Then, as shown in FIG. 5, a part of the gate electrode layer 5 and the insulating layer 4 is etched to cause a gate aperture portion 6 to be formed.

In the field emission type cold cathode of this embodiment, the carbon nano-tube 3a having a length being larger than the thickness of the insulating layer 4 is not contained in the emitter layer 3, unlike in the case of the conventional one shown in FIG. 25, no places where an emitter layer 3 is contacted with a gate electrode layer 5 through the carbon nano-tube is found. Even if the carbon nano-tubes get interwound with each other to form small flocks, since their diameter is very small, the emitter being excellent in flatness is obtained. In the embodiment, the single layered carbon nano-tube is used, however, a same effect can be obtained by using a multi-layered carbon nano-tube. Since the multi-layered carbon nano-tube is lower in flexibility than the single-layered carbon nano-tube, the multi-layered carbon nano-tube is unlikely to get interwound and, as a result, by using the multi-layered carbon nano-tube, the emitter layer 3 being excellent in flatness can be obtained.

### Second Embodiment

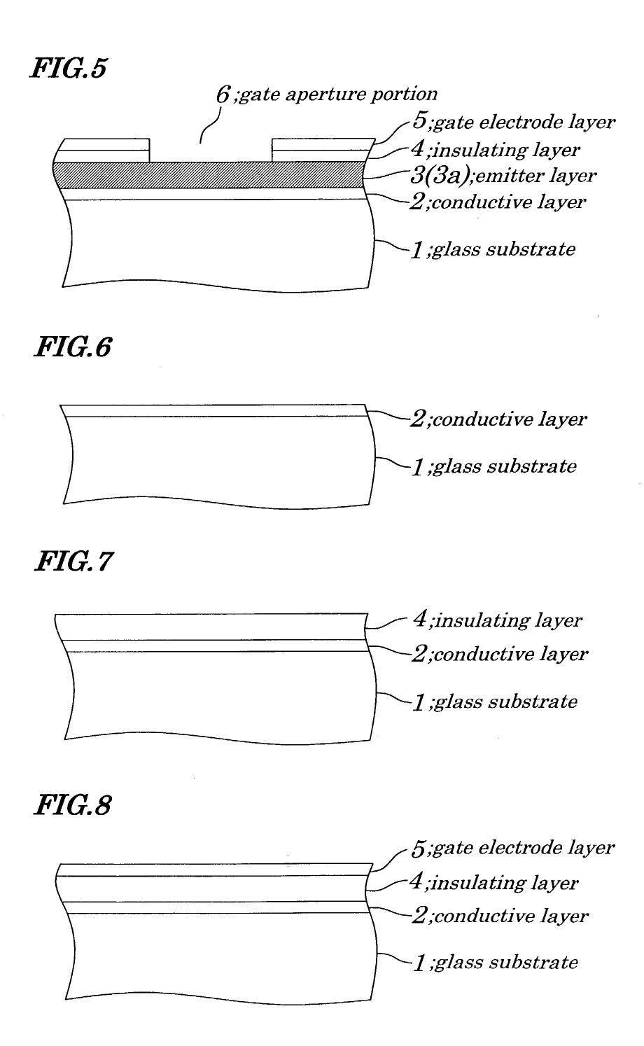

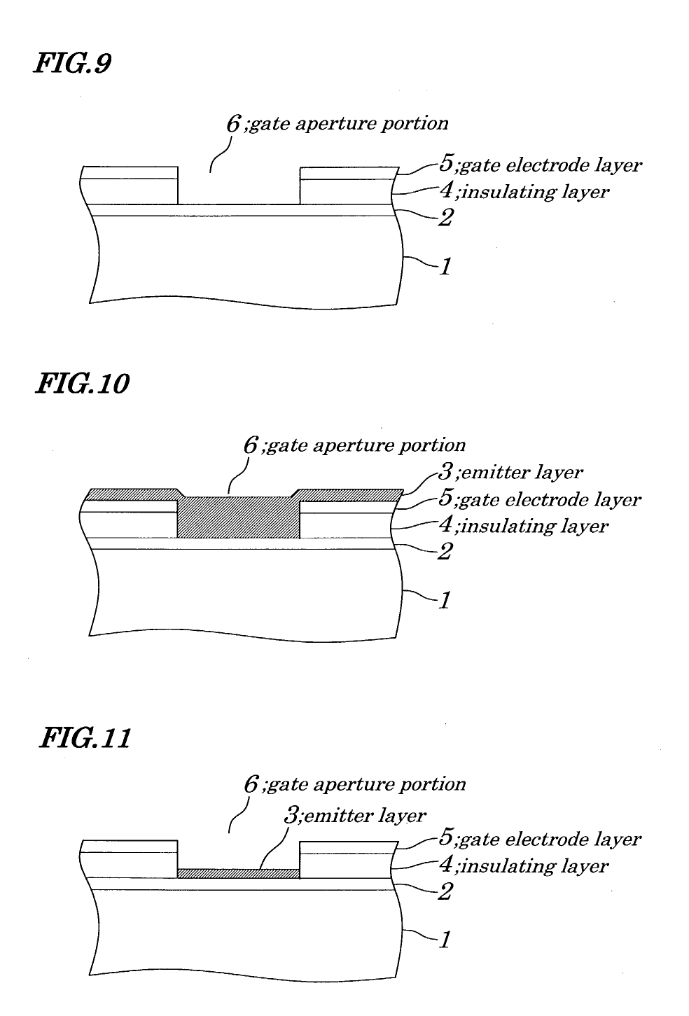

FIGS. 6 to 11 are cross-sectional views of a field emission type cold cathode to explain its manufacturing process according to a second embodiment of the present invention. The manufacturing process in the second embodiment differs greatly from that in the first embodiment in whether an emitter is formed before or after a formation of an insulating layer and a gate electrode layer. First, as shown in FIG. 6, a conductive layer 2 is formed on a glass substrate 1. As shown in FIG. 7, a insulating layer 4 composed of a silicon oxide film, polyimide film or a like with a thickness of 3 μm is stacked on the conductive layer 2. Then, as shown in FIG. 8, an aluminum layer as a gate electrode layer 5 with a thickness of 0.5 μm is stacked on the insulating layer 4. As shown in FIG. 9, a part of the gate electrode layer 5 and the insulating layer 4 is etched in order to cause a gate aperture portion 6 to be formed. Then, as shown in FIG. 10, the gate aperture portion 6 and the gate electrode layer 5 are coated with a binder containing carbon nano-tube having a length being not more than 0.8 μm and then are heated to about 400° C. in a vacuum or in an inert gas such as nitrogen. A method for forming an emitter may include, besides the coating of the binder, a screen printing, atomization or a like. The carbon nano-tube stacked on the gate electrode layer 5 and the gate aperture portion 6 is etched by irradiation of oxygen plasma so that the emitter layer 3 with a thickness of 2 μm is left only at the bottom of the gate aperture portion 6 as shown in FIG. 11. By configuring as above, as in the case of the first embodiment, the gate electrode layer 5 is disposed so that there is the insulating layer 4 with a thickness of 1 μm between a surface of the emitter layer 3 and a bottom of the gate electrode layer 5, that is, there is a distance of 1 μm between the surface of the emitter layer 3 and the bottom of the gate electrode layer 5. The length of the carbon nano-tube is smaller than the thickness of the insulating layer 4 described in the first embodiment. If a process should be carried out by using the binder containing the carbon nano-tube having the length being not less than 1 μm, a big flock of the carbon nano-tube would occur on the gate electrode layer 5 or the gate aperture portion 6, thus making it difficult to reduce the film thickness of the emitter layer 3 in the gate aperture portion 6. Moreover, in many cases, even after the irradiation of oxygen plasma, the flocks of the carbon nano-tube are left on the gate electrode layer 5 and, if they adhere to the gate aperture portion 6, it causes a short-circuit between the emitter layer 3 and the gate electrode layer 5. However, in the field emission type cold cathode according to the embodiment, since the emitter layer 3 is composed only of the carbon nano-tube having the length being smaller than the film thickness of the insulating layer, even if the carbon nano-tube should get interwound to produce the flock, the diameter of the flock is comparatively small, presenting no problem. According to the 10 second embodiment, unlike in the case of the first embodiment, since the emitter layer 3 is formed after the formation of both the insulating layer 4 and gate electrode layer 5, though a bending in the insulating layer 4 and gate electrode layer 5 does not occur, the process of etching the carbon nano-tube by using oxygen plasma is added.

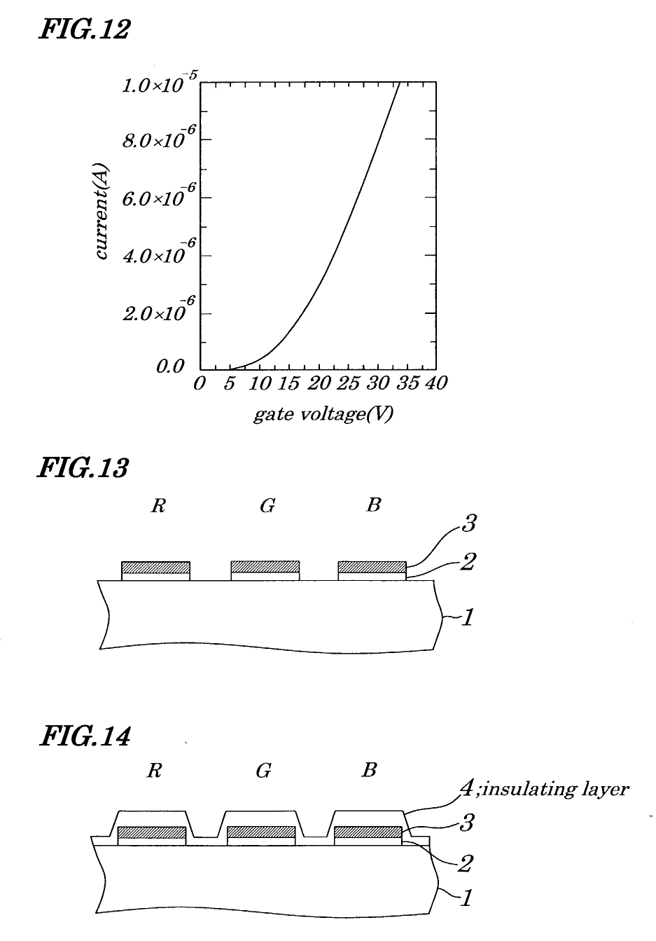

Electron emission characteristics in the field emission type cold cathode fabricated according to the first and second embodiments described above are shown in FIG. 12. It shows a relationship between a voltage (gate voltage) applied to a gate electrode and an amount of emitted currents. The amount of emitted currents is a value of currents detected when a voltage of 500 V is applied to an emitter while an anode electrode is disposed at a position being 1 cm apart from a device. The film thickness of the insulating layer 4 is 1 μm and the gate aperture portion 6 is of a 5 μm square. The current flowing through the gate is not more than nA in the current value. An excellent device characteristic having small insulation leak and small electron expansion is obtained. The amount of emitted currents reaches 10 μA when the gate voltage is about 35 V. Moreover, from an experiment it is confirmed that such electron emission characteristics can be achieved with good reproducibility. Moreover, since the emitter is composed of the carbon nano-tube having the small length, a tip area on which electrons are concentrated is widened, thus causing an amount of emitted electrons to be increased. In this connection, in the field emission type cold cathode formed without control on the length of the carbon nano-tube, there is a dispersion in its characteristic among devices, in which the amount of emitted currents is 0.1 μA at a maximum when the gate voltage is 35 V. Furthermore, since an increase in such electron emission areas is effective in averaging a change in currents at each electron emission point, current stability can also be improved.

### Third Embodiment

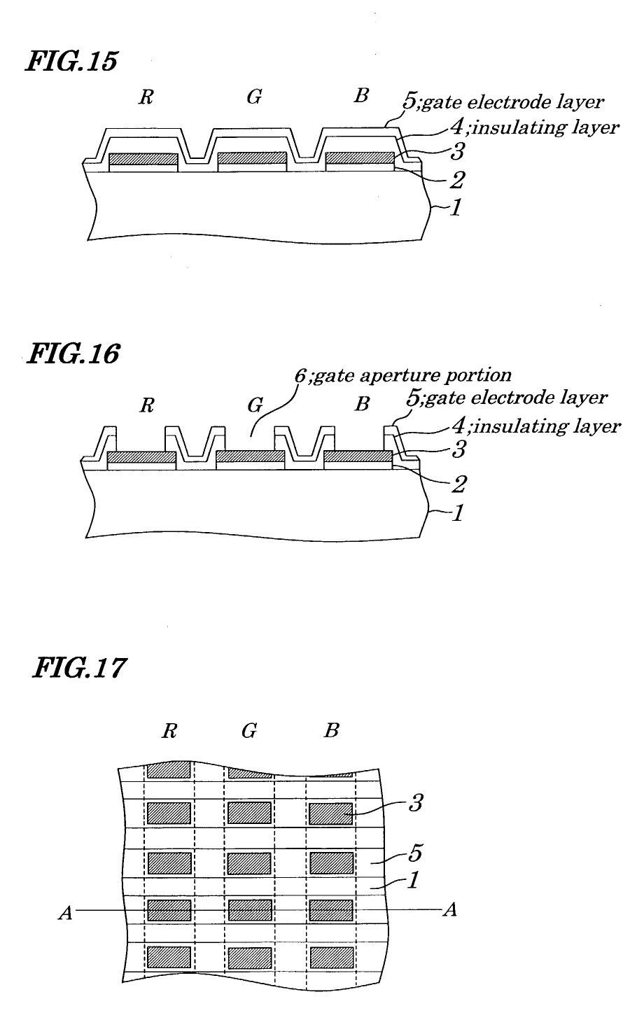

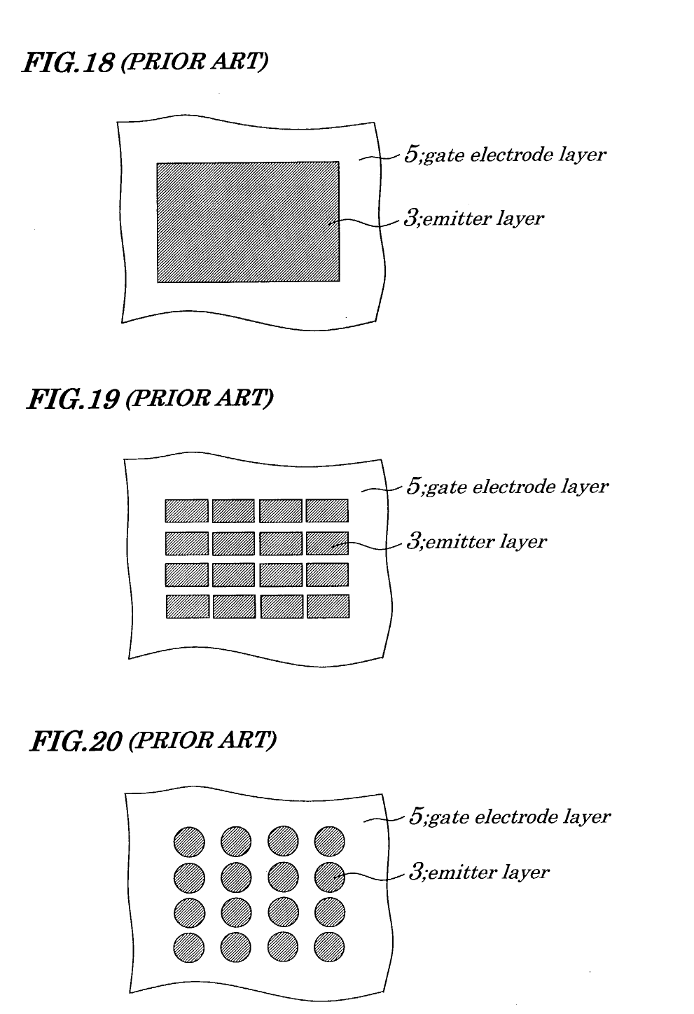

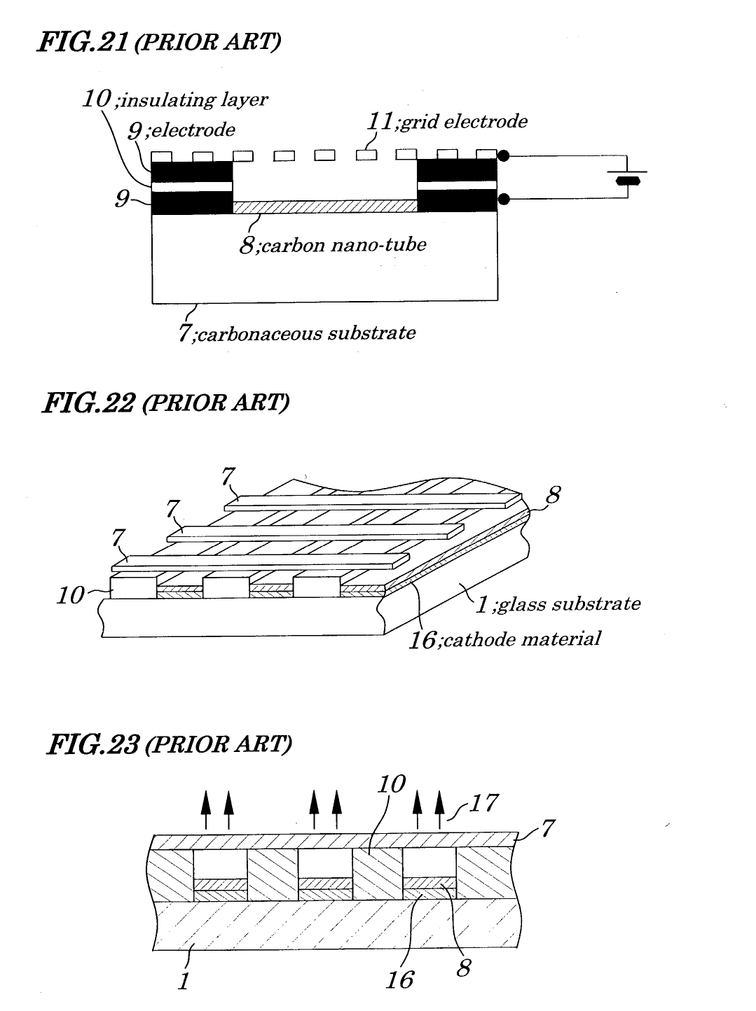

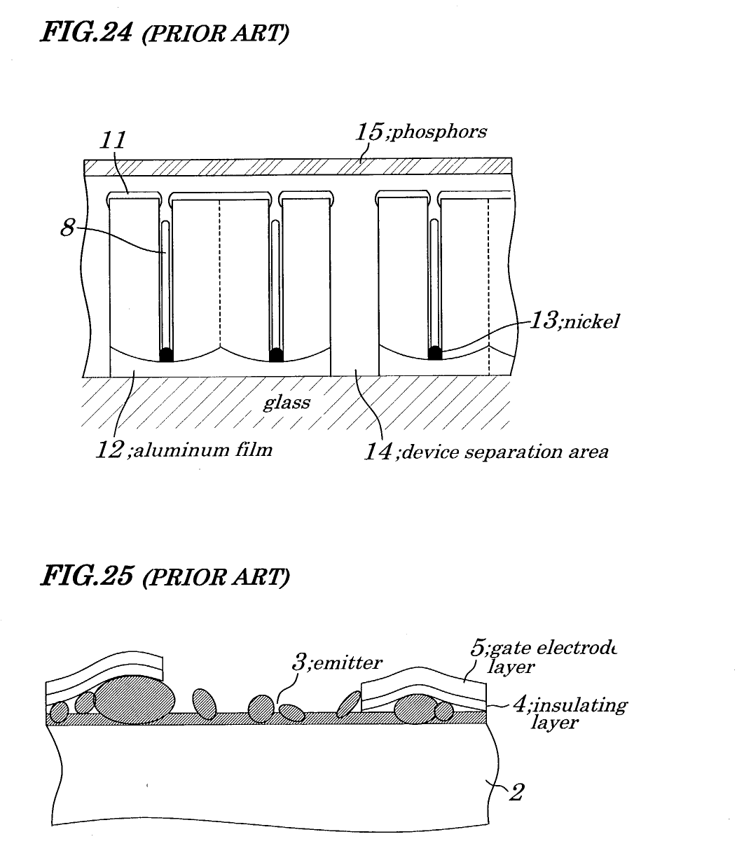

FIGS. 13 to 16 are cross-sectional views of a flat display of FIG. 17 taken along a line A-A to explain its manufacturing processes which are based on manufacturing processes for a field emission type cold cathode provided in the above first embodiment of the present invention. As shown in FIG. 13, a conductive layer 2 is formed on a glass substrate 1 in a direction perpendicular to a paper surface of drawing in a stripe-like form so as to have a thickness of 0.5 μm. The conductive layer 2 is coated with a binder containing carbon nano-tube having a length being not more than 0.8 μm and is adhered to the conductive layer 2 in a same manner as in the first embodiment to cause an emitter layer 3 to be formed. Portions of stripe-shaped conductive layer 2 and the emitter layer 3 correspond to a portion encircled by dot lines in FIG. 17. A whole structure shown in FIG. 13 is covered with an insulating layer with a thickness of 1 μm composed of an oxide film or a polyimide film, as shown in FIG. 14. Then, as shown in FIG. 15, a stripe-like gate electrode layer 5 with a thickness of 0.5 μm is formed in a direction parallel to a paper surface of drawing. The formed gate electrode layer 5 and insulating layer 4 are etched so as to be a square area of a 100 μm square in order to provide each picture element for RGB (Red, Green and Blue) colors to cause a gate aperture portion 6 to be formed as shown in FIG. 16. This causes electron emission portion corresponding to each picture element for RGB to be formed. In this embodiment, the emitter is formed in accordance with the method used in the first embodiment, however, the method used in the second embodiment may be applied as well. An example in which each area in the flat display to provide each of picture elements is composed of the area of a 100 μm square is described above. However, if the area of the emitter is made larger, an intensity of the electric field inevitably becomes non-uniform in areas surrounding the gate aperture portion 6 and in its center area. This is because a gate voltage becomes large in the emitter surface being near to the gate electrode. Therefore, in the flat display in which one picture element is large or an electron emission device in which its emitter area is comparatively large, it is necessary to improve uniformity in electric field distribution on the surface of the emitter. FIG. 18 shows an emitter layer 3 having one gate aperture portion in the gate electrode layer 5. FIG. 19 is a diagram in which one emitter is divided into a plurality of rectangles or squares. This allows a distance between the area surrounding a divided gate aperture portion and the center area at the gate aperture portion to be shortened, thus enabling an application of a uniform electric field to the surface of the emitter within the aperture portion. Moreover, the gate aperture portion may be divided into polygons such as hexagons or, for example, into circles as shown in FIG. 20. Thus, by dividing the gate aperture portion, the electric field distribution within the emitter area is made uniform and uniform high emission current may be obtained. However, if the gate aperture is divided into predetermined emitter areas, since the area of the gate electrode occupying the emitter area is increased, the emitter area is substantially decreased accordingly. Therefore, when the device is designed, by reducing a width of the gate electrode in the emitter area, an effective emitter area must be made as large as possible.

As described above, by extracting the carbon nano-tube having the length being not more than, at least, the film thickness of the insulating layer and using it as the emitter, it is possible to manufacture the field emission type cold cathode and the flat display providing stable and uniform operations. When the length of the carbon nano-tube used in the first, second and third embodiments is to be controlled, since the carbon nano-tube having the length (1 mm in this case) being smaller than the film thickness of the insulating layer is contained in a crude product, it can be separated and extracted only by filtering the crude product. However, a yield obtained by the filtering is low and most of produced carbon nano-tube is not utilized. Moreover, if the film thickness of the insulating layer becomes not more than 0.5 μm, since the carbon nano-tube having the length being not more than the film thickness does not exist in the crude product, effect intended by the present invention cannot be implemented by the method described above. To fully utilize the produced carbon nano-tube and to obtain the carbon nano-tube having a small length, the following methods are effective.

A first method is to pulverize the carbon nano-tube and to divide long carbon nano-tube into pieces. By mechanically dividing the carbon nano-tube obtained after purification by using a pulverizing machine such as a mortar, ball mill or a like, it is possible to obtain many comparatively short carbon nano-tubes. Also, by mixing minute spheres of alumina, zirconia or a like, with a high hardness, at a time of the pulverization, a pulverizing efficiency can be improved. After the pulverization, only the carbon nano-tube having the length being not more than a predetermined length is separated and extracted by same methods as described above. This allows the yield of the carbon nano-tube to be improved and the carbon nano-tube having the length being not more than 0.5 m to be obtained.

A second method is to heat the carbon nano-tube in a gas containing an oxidizing agent (air, oxygen, water, carbon dioxide or a like) in order to make its length smaller. The method for purifying the carbon nano-tube is disclosed in Japanese Patent Application Laid-open Hei7-48110. This method is based on a characteristic that both tips of the carbon nano-tube are readily lost in reaction to oxygen. When multi-layered carbon nano-tubes are heated in atmosphere, a suitable temperature is 700° C. to 1000° C. When single-layered carbon nano-tubes are heated in the atmosphere, since they are likely to be lost compared with the multi-layered carbon nano-tubes, the suitable temperature is 450° C. to 600° C. A period of time for heating can be calculated inversely from the time when tips of the carbon nano-tubes are lost in reaction to oxygen so that the yield of the carbon nano-tube having the length being not more than an intended length may be made maximum. The carbon nano-tube obtained by being heated is suspended in alcohol and then the carbon nano-tube having the length being not more than a desired length is separated and extracted by using a filter. Since this method causes the carbon nano-tube itself to be lost in reaction to oxygen, though its yield is lowered, it is possible to easily obtain the carbon nano-tube having small length. Moreover, by making use of a characteristic that a burning rate of an impurity such as graphite, amorphous carbon or a like is higher than that of the carbon nano-tube, control of the length of the carbon nano-tube and purification of the carbon nano-tube can be simultaneously implemented by only using the above method.

A third method is to divide the carbon nano-tube by irradiation of a convergent ion beam having high energy into pieces. The suspension of the carbon nano-tube obtained by the purification is heated to cause ethanol to be evaporated. Then the carbon nano-tube is put into convergent ion beam generating equipment and is irradiated with ion beams of Ga (Gallium), Au (Gold) or a like so that the carbon nano-tube is divided as desired.

The field emission type cold cathode containing the carbon nano-tube the length of which is controlled by the above three methods can produce a greater amount of emitted currents compared with the field emission type cold cathode obtained by methods provided in the first, second and third embodiments. It seems to be because a defect occurs in the tip portion or the side portion of the carbon nano-tube due to the dividing or burning of the carbon nano-tube, causing the electric field to be concentrated on these areas. Therefore, by using three methods for controlling the length of the carbon nano-tube described above, it is possible to obtain much greater amounts of emitted currents.

Thus, according to the present invention, by using the carbon nano-tube having the length being smaller than, at least, the film thickness of the insulating layer for the emitter, the field emission type cold cathode and the flat display can be manufactured which is capable of maintaining insulation between the gate electrode and the emitter, of improving flatness on the emitter surface and of generating uniform and stable high emission currents.

It is thus apparent that the present invention is not limited to the above embodiments but may be changed and modified without departing from the scope and spirit of the invention.

Finally, the present application claims the priority of Japanese Patent Application No. Hei11-145900 filed on May 26, 1999, which is herein incorporated by reference.

What is claimed is:

1. A field emission type cold cathode comprising:
an emitter composed of a carbon-nano tube;
an insulating layer disposed so as to surround said emitter;
a gate electrode; and
whereby an electron is emitted by applying a voltage to said emitter and a length of said carbon nano-tube is smaller than a film thickness of said insulating layer.

2. The field emission type cold cathode according to claim 1, wherein the length of said carbon nano-tube is smaller than that expressed by “d−Vg/Eb”, where “d” represents the film thickness of said insulating layer, “Vg” represents said voltage to be applied to said emitter and “Eb” represents dielectric strength of said insulating layer.

3. A method for manufacturing a field emission type cold cathode comprising steps of:
fixing an emitter material composed of a carbon nano-tube having a length being smaller than a film thickness of an insulating layer on a conductive layer formed on a conductive substrate or a glass substrate;
forming said insulating layer and a gate electrode layer, in order, on said emitter material; and
etching said insulating layer and said gate electrode layer to cause an aperture portion to be formed.

4. A method for manufacturing a field emission type cold cathode comprising steps of:
forming an insulating layer and a gate electrode layer, in order, on a conductive layer formed on a conductive substrate or a glass substrate;
etching said insulating layer and said gate electrode layer to cause an aperture portion to be formed;
fixing an emitter material composed of a carbon nano-tube a length of which is controlled so as to be smaller than, at least, a film thickness of said insulating layer on said aperture portion and said gate electrode layer; and
etching said emitter material to cause said emitter material to be left only in a gate aperture portion.

5. The method for manufacturing the field emission type cold cathode according to claim 3, wherein control of the length of said carbon nano-tube is made by filtering said carbon nano-tube to separate and extract said carbon nano-tube having a specified length.

6. The method for manufacturing the field emission type cold cathode according to claim 3, wherein control of the length of said carbon nano-tube is made by pulverizing and filtering said carbon nano-tube to separate and extract said carbon nano-tube having a specified length.

7. The method for manufacturing the field emission type cold cathode according to claim 3, wherein control of the length of said carbon nano-tube is made by heating said carbon nano-tube in a gas containing an oxidizing agent including oxygen and by filtering said carbon nano-tube to separate and extract said carbon nano-tube having a specified length.

8. The method for manufacturing the field emission type cold cathode according to claim 3, wherein control of the length of said carbon nano-tube is made by irradiating said carbon nano-tube with an ion beam and by filtering said carbon nano-tube to separate and extract said carbon nano-tube having a specified length.

9. The method for manufacturing the field emission type cold cathode according to claim 4, wherein control of the length of said carbon nano-tube is made by filtering said carbon nano-tube to separate and extract said carbon nano-tube having a specified length.

10. The method for manufacturing the field emission type cold cathode according to claim 4, wherein control of the length of said carbon nano-tube is made by pulverizing and filtering said carbon nano-tube to separate and extract said carbon nano-tube having a specified length.

11. The method for manufacturing the field emission type cold cathode according to claim 4, wherein control of the length of said carbon nano-tube is made by heating said carbon nano-tube in a gas containing an oxidizing agent including oxygen and by filtering said carbon nano-tube to separate and extract said carbon nano-tube having a specified length.

12. The method for manufacturing the field emission type cold cathode according to claim 4, wherein control of the length of said carbon nano-tube is made by irradiating said carbon nano-tube with an ion beam and by filtering said carbon nano-tube to separate and extract said carbon nano-tube having a specified length.

13. A method for manufacturing a flat display comprising steps containing processes for manufacturing the field emission type cold cathode as defined in claim 3.

14. A method for manufacturing a flat display comprising steps containing processes for manufacturing the field emission type cold cathode as defined in claim 4.
